(19) United States
(12) Patent Application Publication
(10) Pub. No.: US 2013/0171523 A1
(43) Pub. Date: Jul. 4, 2013

(54) LITHIUM-ION SECONDARY BATTERY AND THE CATHODE MATERIAL THEREOF

(71) Applicants: Zhi CHEN, Dongguan (CN); Ying WANG, Dongguan (CN); Fengguan ZHAO, Dongguan (CN); Zilong YU, Dongguan (CN); Yuansen XIE, Dongguan (CN); Jianxun REN, Dongguan (CN); Jiajai HU, Dongguan (CN); Leimin XU, Dongguan (CN)

(72) Inventors: Zhi CHEN, Dongguan (CN); Ying WANG, Dongguan (CN); Fengguan ZHAO, Dongguan (CN); Zilong YU, Dongguan (CN); Yuansen XIE, Dongguan (CN); Jianxun REN, Dongguan (CN); Jiajai HU, Dongguan (CN); Leimin XU, Dongguan (CN)

(21) Appl. No.: 13/338,240

(22) Filed: Dec. 28, 2011

(51) Int. Cl. H01M 4/131; H01B 1/00

(52) U.S. Cl. 429/221; 429/223; 429/224; 429/229; 429/231.5; 429/231.6; 429/231.95; 252/519.15; 252/519.1; 252/519.12

(57) ABSTRACT

The present invention relates to the field of lithium-ion battery, and particularly to high-capacity cathode material, and high-energy density lithium-ion secondary battery prepared using the same. The cathode material comprises cathode active material, a binder and a conductive agent, in which the cathode active material is a compound material of lithium cobalt oxide-based active material A and nickel-based active material B pretreated before being mixed, and the mass ratio B/A of the lithium cobalt oxide-based active material A and nickel-based active material B is between 0.82 and 9. The present invention can produce a battery having both larger capacity and higher energy density, and address the problem of gas generation in the battery at high temperature.

### TECHNICAL FIELD

The present invention relates to the field of lithium-ion battery, and particularly to high-capacity cathode material, and high-energy density lithium-ion secondary battery prepared using the same.

### BACKGROUND OF THE INVENTION

Lithium-ion secondary battery has become one of the mostly widely used secondary batteries due to its advantages of high voltage, and high energy density. With the continuous development of micromation and long standby time of portable electronic devices, the energy density, especially volumetric energy density, of lithium-ion battery which acts as power source is continuously improved to meet increasing demands.

At present, the cathode material used in the mostly well-established energy-type lithium-ion secondary battery is lithium cobalt oxide. The cathode film consisted of lithium cobalt oxide can achieve a compacted density of up to 4.1 g/cc without adversely affecting the battery properties, and have good cycle performance. However, since its specific capacity is only 140 mAh/g, further improving of its specific capacity can destroy the layered structure thereof, adversely affecting reversible charge and discharge, and bring about great safety risk. Therefore, the use of lithium cobalt oxide as cathode material can not meet the demands for high-energy density battery any more.

The studies of cathode materials replacing lithium cobalt oxide mainly focus on cathode materials having layered structure and relatively high nickel content. These high-nickel layered-structure cathode materials are of hexagonal structure, the same as lithium cobalt oxide, and have higher specific capacity than lithium cobalt oxide, with an actual capacity of up to 180-190 mAh/g. However, they have an actual compacted density of only 3.6 g/cc. The application of high-nickel layered-structure cathode in lithium-ion secondary batteries suffers a lot of troubles, mainly due to the reason of gas generation in the lithium-ion secondary batteries during high-temperature storage, which results in volume swelling in softly packaged lithium-ion secondary battery, and pressure increase in lithium-ion secondary battering using steel housing, leading to serious safety risk.

Mixing high-nickel layered-structure cathode material having suitable particle size and lithium cobalt oxide can improve the space utilization of the cathode film and achieve a compacted density of about 4.1 g/cc for the cathode film, and at the same time greatly improve the specific capacity relative to lithium cobalt oxide. The mixed material combines the advantages of lithium cobalt oxide and high-nickel layered-structure cathode material and increase the energy density compared with lithium cobalt oxide. The battery having a cathode made of the mixed material has the advantages of good electrochemical performance, safety performance, and high energy density. A cathode material was disclosed, for example, in Chinese Patent Publication CN 1848492, which comprises a cathode active material, a binder, and a conductive agent, wherein the cathode active material is a compound material of lithium cobalt oxide-based active material A having a formula of LiₓCo_{y}Ma_{(1-y)}O₂, where 0.45≦x≦1.2, 0.8≦y≦1, and Ma is one or more of Al, Mn, Fe, Mg, Si, Ti, Zn, Mo, V, Sr, Sn, Sb, W, Ta, Nb, Ge and Ba; and nickel-based material B having a formula of LiₓNiₐCo_{b}Mb_{(1-a-b)}O₂, where 0.45≦x1≦1.2, 0.7≦a≦0.9, 0.08≦b≦0.3, 0.78≦a+b≦1, Mb is one or more of Al, Mn, Mg, Fe, Ti, Zn, Mo, V, Sr, Sn, Sb, W, Ta, Nb, Ge and Ba; B/A is 0.04-0.8, and the compacted density of the cathode material has a compacted density of larger than 3.7 g/cc.

The mixing of nickel-based material and lithium cobalt oxide-based active material can provide a battery with higher capacity and higher energy density, and improving the mixing ratio of the nickel-based material and lithium cobalt oxide-based active material facilitates improving the capacity and energy density of the battery. The improving of the mixing ratio of the nickel-based material and lithium cobalt oxide-based active material depends on the decrease in gas production of the nickel-based material in the battery at high temperature. However, the Chinese Patent Publication CN 1848492 failed to solve the problem of gas production of the nickel-based material in the battery at high temperature, and thus provided a relatively low weight ratio of the nickel-based material over the lithium cobalt oxide, that is, 0.04˜0.8. Since the specific capacity of the nickel-based material is higher than that of lithium cobalt oxide, the relatively low content of the nickel-based material directly affects the increase in specific capacity of cathode material being mixed, which in turn limits the increase in energy density.

### SUMMARY OF THE INVENTION

The object of the present invention is to address the disadvantages existing in the prior art, and provide a cathode material for lithium-ion secondary battery, which enables the production of a battery with higher capacity and higher energy density, while solving the problem of gas production in the battery at high temperature.

The above object can be achieved by adopting the following technical solutions: A cathode material for lithium-ion secondary battery comprising cathode active material, a binder, and a conductive agent, wherein the cathode active material is a compound material of lithium cobalt oxide-based active material A, having a formula of LiₓCo_{y}Ma_{(1-y)}O₂, where 0.45≦x≦1.2, 0.8≦y≦1, Ma is one or more of Al, Mn, Fe, Mg, Si, Ti, Zn, Mo, V, Sr, Sn, Sb, W, Ta, Nb, Ge and Ba; and nickel-based active material B, having a formula of Liₓ₁NiₐCo_{b}Mb_{(1-a-b)}O₂, wherein 0.45≦x1≦1.2, 0.7≦a≦0.9, 0.08≦b≦0.3, 0.78≦a+b≦1, Mb is one ore more of Al, Mn, Mg, Fe, Ti, Zn, Mo, V, Sr, Sn, Sb, W, Ta, Nb, Ge and Ba; the nickel-based active material B is pretreated before being mixed with the lithium cobalt oxide-based active material A, and the mass ratio B/A of the lithium cobalt oxide-based active material A and the nickel-based active material B is between 0.82 and 9.

By using the lithium cobalt oxide-based active material A and the nickel-based active material B by a mass ratio B/A of between 0.82 and 9, the content of nickel-based active material B is greatly improved. The resultant mixture combines both the advantages of high compacted density from the lithium cobalt oxide-based active material A and the advantages of high capacity from the nickel-based active material B, to provide a cathode material having higher energy density. In addition, the pretreatment adopted for the nickel-based active material B addresses the disadvantages of gas generation of the nickel-based active material B in the batteries during high-temperature storage, so that the obtained batteries can achieve both higher energy density and better high-temperature storage performance, and comply with safe requirements as well.

The nickel-based active material B is pretreated before being mixed so as to improve the ratio of the nickel-based active material B, and further improve the capacity and energy density of the lithium-ion secondary battery thus prepared, while significantly reducing gas generation of the nickel-based active material B in batteries during high-temperature storage.

In the above aspect, the nickel-based active material B is pretreated by surface coating, that is, surface coating with a layer of oxide of M which is any of Mg, Al, Zr, Zn, Ti, Cu, and B.

The surface coating can be performed by liquid phase deposition: adding the nickel-based active material B to a solution of a compound containing element M in a solvent of water or ethanol, and adding another solution such as ammonia water, ammonium hydrogen carbonate solution, nitrate solution, and the like to deposit or gelate M. Then, the temperature, pH value, and the reaction time of the solution is adjusted to control reaction speed and surface coating amount, so that the surface of the nickel-based active material B is uniformly surface coating with a layer of the compound containing M. the surface coating nickel-based active material B is subjected to solid-liquid separation to provide a solid phase, which is dried at 80-100° C. and then baked at 300-900° C. for 2-10 h to provide the final nickel-based active material B with the surface being uniformly surface coating with a layer of the compound containing M.

In the above aspect, the nickel-based active material B is pretreated in de-ionized water, subjected to solid-liquid separation (which can be performed by centrifuging to separate from water), and baked in vacuum to remove moisture. The pH value of the de-ionized water is between 5.5 and 7, the weight ratio of the nickel-based active material B and the de-ionized water is between 1:2 and 1:10, the washing is performed for between 1 and 20 minutes, and the vacuum drying is performed under a vacuum of lower than 100 Pa at 80-150° C. for 10-20 hours, to remove the moisture remained in the nickel-based active material B.

In the above aspect, for the purpose of achieving higher compacted density for the cathode material, the average particles size of the lithium cobalt oxide-based active material A and the nickel-based active material B can be optimized, that is, the average particles size D50 of the lithium cobalt oxide-based active material A is between 15 and 22 μm, the average particles size D50 of the nickel-based active material B is between 8-14 μm, and the D50 ratio of A and B is between 1.07 and 2.75. The average particle size D50 as used herein refers to the particle size corresponding to an accumulated particle size volume distribution percentage of 50% measured by using laser diffraction-scattering type particle size distribution analyzer.

In the above aspect, the compacted density of a lithium-ion secondary battery according to the present invention is between those of the lithium cobalt oxide-based active material A and the nickel-based active material B, and is larger than or equal to 3.7 g/cc.

In the above aspect, the mass ratio B/A of the lithium cobalt oxide-based active material A and the nickel-based active material B is between 1.5 and 9.

In the above aspect, the mass ratio B/A of the lithium cobalt oxide-based active material A and the nickel-based active material B is 1.67.

In the above aspect, the lithium cobalt oxide-based active material A is LiCo02 having a particle size D50 of 18 μm, and the nickel-based active material B is Li_{1.02}Ni_{0.78}Co_{0.20}Al_{0.02}O₂ having a particle size D50 of 12 μm.

Another object of the present invention is to provide a lithium-ion secondary battery having high-energy density.

The object is achieved by the following technical solution:

A lithium-ion secondary battery, comprising a cathode, an anode, electrolyte, and a separator membrane, wherein the cathode is a compound material of the lithium cobalt oxide-based active material A and the nickel-based active material B described above, with a mass ratio B/A of between 0.82 and 9.

The battery according to the present invention has higher capacity and higher energy density, and is free from safety risk due to gas generation during high-temperature storage, leading to good high-temperature storage performance.

### BRIEF DESCRIPTION OF THE DRAWINGS

FIG. 1 shows the diagram of the compacted density of the cathode film and the specific capacity of the cathode active material as a function of the mass ratio B/A of the nickel-based active material B and the lithium cobalt oxide-based active material A in the examples of the present invention and the comparative examples;

FIG. 2 is the diagram of the battery capacity as a function of the mass ratio B/A of the nickel-based active material B and the lithium cobalt oxide-based active material A in the examples of the present invention and the comparative examples;

FIG. 3 is the diagram of the battery energy density as a function of the mass ratio B/A of the nickel-based active material B and the lithium cobalt oxide-based active material A in the examples of the present invention and the comparative examples; and

FIG. 4 is the diagram of the thickness swelling rate of the batteries after high-temperature storage at 85° C. for 4 hours as a function of the mass ratio B/A of the nickel-based active material B and the lithium cobalt oxide-based active material A in the examples of the present invention and the comparative examples.

### DETAILED DESCRIPTION OF PREFERRED EMBODIMENTS

The lithium-ion secondary battery according to the present invention and the cathode material thereof will be described in detail below in combination with the drawings and specific examples.

The lithium-ion secondary battery has the following cathode: a cathode film formed on one or two sides of a planar or net-like conductive substrate serving as a current collector, and containing cathode active material, a conductive agent, and a binder.

The active material contained in the cathode film is a compound material of the lithium cobalt oxide-based active material A and the nickel-based active material B. the lithium cobalt oxide-based active material A has a formula of LiₓCo_{y}Ma_{(1-y)}O₂, where 0.45≦x≦1.2, 0.8≦y≦1, Ma is one or more of Al, Mn, Fe, Mg, Si, Ti, Zn, Mo, V, Sr, Sn, Sb, W, Ta, Nb, Ge and Ba; the value of x representing the content of lithium is between 0.95 and 1.2 during non-charge and non-discharge period, and is preferably between 1.0 and 1.2, since excessive x value will lead to increased impurities containing lithium, whereas too small value of x will affect the capacity of the batteries. With lithium ions being deinserted and moving toward the anode during charge, the value of x constantly decrease, but should be larger than 0.45, otherwise the structure of the cathode material will be destroyed, and the reversibility of charge and discharge will be reduced. Correspondingly, the value of x is preferably between 0.45 and 1.2.

The nickel-based active material B has a formula of Liₓ₁NiₐCo_{b}Mb_{(1-a-b)}O₂, where 0.45≦x1≦1.2, 0.7≦a≦0.9, 0.08≦b≦0.3, 0.78≦a+b≦1, Mb is one or more of Al, Mn, Mg, Fe, Ti, Zn, Mo, V, Sr, Sn, Sb, W, Ta, Nb, Ge and Ba; the value of a representing the content of nickel determines the specific capacity of the nickel-based active material B, and is preferably between 0.7 and 0.9, since too small value of a will result in relatively low specific capacity, and limit the improving of the capacity relative to that of lithium cobalt oxide-based active material A, whereas too large value of a will result in unstable material structure. The value of b representing the content of cobalt is preferably between 0.08 and 0.3, since too small value of b will deteriorate the load properties of the material, whereas too large value of b will increase material cost and reduce specific capacity. The doped element Mb which serves to stabilize the structure of the nickel-based active material is preferably Al and Mn, and preferably has a content (1−a−b) of between 0.01 and 0.1.

The weight ratio of the nickel-based active material B and the lithium cobalt oxide-based active material A in the cathode material is between 0.82 and 9, since too low content of the nickel-based active material B will result in the loss of the advantages of the compound material in terms of specific capacity over the lithium cobalt oxide-based active material, whereas too large content of the nickel-based active material B will reduce the compacted density of the compound material, adversely affect the energy density of the battery, and result in serious gas generation in the battery during high-temperature storage, leading to battery failure.

The compacted density of the above cathode film is larger than or equal to 3.7 g/cc, preferably larger than or equal to 3.75 g/cc. A relatively large compacted density can be achieved by reducing the gap between pressure rollers, increasing the pressure between pressure rollers, slowing the rotating speed of the pressure rollers, increasing the temperature of the pressure rollers, and the like. The compacted density of the cathode film is measured as follows. A disc having a certain area is cut out of compacted cathode electrode (standing by for no more than 24 hours after being compacted and not subjected to baking treatment), and weighed on an electronic balance with a minimum scale of 1 mg to provide the weight of the disc, which is then subtracted by the weight of the current collector having the same area to provide the weight of the disc. On the other hand, the thickness of the cathode electrode is measured by a micrometer screw gauge with a minimum scale of 0.001 mm, and is then subtracted by the thickness of the current collector to provide the thickness of the cathode film. Then, the compacted density of the cathode film is obtained by dividing the weight of the cathode film by the volume of the cathode film to provide the compacted density of the cathode film.

The conductive agent contained in the cathode film is preferably carbon material such as carbon black, acetylene black, graphite, carbon fiber, carbon nanotubes and the like, and preferably has smaller particle size, that is, 10-5000 μm, and larger BET (specific area) which is at least 20 times or more than that of the mixed active material (containing the nickel-based active material B and the lithium cobalt oxide-based active material A). The binder used in the cathode film can be selected from polyvinylidene fluoride-based polymer (for example, PVDF), rubber-based polymers (for example SBR), and the like.

The current collector of the cathode electrode can be selected from metal conductive material such as net-like or planar foil-like aluminum, stainless steel, titanium, and the like, and preferably has a thickness of 8-20 μm. The cathode slurry (consisted of cathode active material, a binder, a conductive agent and a solvent) can be coated on the current collector through currently known coating methods (for example extruding coating, transferring coating, and the like), and baked at high temperature to form a cathode electrode. The viscosity of the cathode slurry is preferably between 1000 and 7000 mPa·S so that the cathode slurry can be uniformly coated on the current collector.

The active material serving as an anode in the present invention can be lithium-deinserted carbon material, silicon-based alloy or the combination thereof. The carbon material can be one or more of hard carbon materials, soft carbon materials, natural graphite, artificial graphite, mesophase carbon micro-balls, and micron-sized carbon fiber. The binder used in the anode film can be selected from styrene-butadiene rubber-based polymers (for example, SBR), cellulose-based polymers (for example, CMC), polyvinylidene fluoride-based polymers (for example, PVDF), and the like. Since the anode active material has good electron conductivity, the anode film can or can not contain a conductive agent, which, if present, is similar to that used in the cathode material. The current collector serving as the anode can be selected from, but not limited to, net-like or foil-like copper, preferably with a thickness of 6-10 μm.

The anode slurry (consisted of anode active material, a solvent, a binder, and/or a conductive agent) can be coated on the anode current collector through currently known coating methods (for example extruding coating, transferring coating, and the like), and baked at high temperature to form an anode electrode. The viscosity of the anode slurry is preferably between 500 and 4000 mPa·S so that the anode slurry can be uniformly coated on the current collector.

The lithium-ion secondary battery can be manufactured as follows: welding conductive plate lugs on the above cathode electrode and anode electrode, coiling the cathode electrode and the anode electroded together with a separator membrane sandwiched therebetween to a spiral shape to form a bare battery, which was then placed in a steel housing (for example, 18650-type cylindrical steel housing) or a package consisted of aluminum-plastic composite material, injecting non-aqueous electrolyte, and sealing.

The separator membrane can be selected from microporous polyethylene, polypropylene, or a composite film thereof, and preferably have a thickness of between 8 and 20 μm. without special limitation to the organic solvent used in the non-aqueous electrolyte, it can be selected from one or more of cyclic carboxylates, and linear carboxylates, for example, the mixture of PC (propylene carbonate) and EC (ethylene carbonate) and DEC (diethyl carbonate). The solute in the non-aqueous electrolyte can be lithium salts containing fluorine such as lithium hexafluorophosphate (LiPF6), or the like, and have a concentration of 0.6-1.4 mol/L in the electrolyte.

### Example 1

Manufacturing of the Cathode:

LiCoO₂ having an average particle size D50 of 18 μm (in which the volume of the LiCoO₂ particles having a particles size of smaller than 18 μm comprises 50% of the total volume of the particles) was used as the lithium cobalt oxide-based active material A; Li_{1.02}Ni_{0.78}Co_{0.20}Al_{0.02}O₂ having an average particle size D50 of 12 μm (in which the volume of the Li_{1.02}Ni_{0.78}Co_{0.20}Al_{0.02}O₂ particles having a particles size of smaller than 12 μm comprises 50% of the total volume of the particles) was used as the nickel-based active material B. The nickel-based active material B was washed by de-ionized water for 15 minutes before being mixed, so as to remove impurities containing lithium (for example, lithium carbonate, lithium hydroxide, or the like), centrifuged, and dried in a vacuum of lower than 100 Pa at 100° C. for 20 hours to remove moisture. The weight ratio of the nickel-based active material B and the lithium cobalt oxide-based active material A B/A was adjusted to 0.82. A slurry containing the above active materials was prepared, in which the solid component comprises 95.5% active material, 2.2% conductive agent (conductive carbon), and 2.3% binder (PVDF), and NMP was used as the solvent, comprising 30% of the total weight of the slurry. The slurry was uniformly coated on both sides of a 12 μm aluminum foil, and calendered on a roller press to provide a cathode film having a compacted density of 4.0 g/cc.

Manufacturing of the Anode:

Artificial graphite having a BET (specific area) of 3.15 m²/g was used as the anode active material. A slurry containing the anode active material was prepared, in which the solid component comprises 95.8% anode active material, 3.2% SBR (styrene butadiene rubber) and CMC (carboxymethylcellulose sodium) as a binder, and 1% conductive carbon as a conductive agent. The slurry comprised water as a solvent, which comprises 55% of the total weight of the slurry. The slurry was uniformly coated on both sides of a 8 μm Cu foil, and calendered on a roller press to provide an anode film having a compacted density of 1.65 g/cc.

Assembling of the Battery:

Conductive plate lugs were welded on the cathode and the anode. The cathode and the anode were laminated with a 16 μm PP/PE composite separator membrane sandwiched therebetween, coiled to a spiral shape, and packed into an 115 μm-thick package of aluminum-plastic composite material, which was injected with non-aqueous electrolyte, and sealed for the battery to degas. The gas was sucked out of the package upon the cathode and the anode were fully degassed, and redundant package was cut off to provide a battery of 4.13 mm thick, 33.58 mm wide, and 80.8 mm high. The main solvent as used was the mixture of EC, PC, and DEC.

### Example 2

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, which was pretreated in the same way as in Example 1, except for being dried in vacuum of lower than 100 Pa at 80° C. for 15 hours to remove moisture. The mass ratio B/A of the nickel-based active material B and the lithium cobalt oxide-based active material A was adjusted to 1.67. The compacted density of the cathode film was modified to 3.9 g/cc. Further, the lithium-ion secondary battery was manufactures in the same way as in Example 1.

### Example 3

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, which was pretreated in the same way as in Example 1. The mass ratio B/A of the nickel-based active material B and the lithium cobalt oxide-based active material A was adjusted to 3. The compacted density of the cathode film was modified to 3.8 g/cc. Further, the lithium-ion secondary battery was manufactures in the same way as in Example 1.

### Example 4

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, which was pretreated in the same way as in Example 2. The mass ratio B/A of the nickel-based active material B and the lithium cobalt oxide-based active material A was adjusted to 9. The compacted density of the cathode film was modified to 3.75 g/cc. Further, the lithium-ion secondary battery was manufactures in the same way as in Example 1.

### Example 5

LiCoO₂ having a particle size D50 of 18 μm was used as the lithium cobalt oxide-based active material A, and Li_{0.98}Ni_{0.77}Co_{0.20}Al_{0.01}Mn_{0.02}O₂ having a particle size D50 of 11 μm was used as the nickel-based active material B, which was pretreated in the same way as in Example 2. The mass ratio B/A of the nickel-based active material B and the lithium cobalt oxide-based active material A was adjusted to 1.67. The compacted density of the cathode film was modified to 3.9 g/cc. Further, the lithium-ion secondary battery was manufactures in the same way as in Example 1.

### Example 6

LiCoO₂ having a particle size D50 of 18 μm was used as the lithium cobalt oxide-based active material A, and Li_{1.07}Ni_{0.78}Co_{0.20}O₂ having a particle size D50 of 13 μm was used as the nickel-based active material B, which was pretreated in the same way as in Example 1. The mass ratio B/A of the nickel-based active material B and the lithium cobalt oxide-based active material A was adjusted to 1.67. The compacted density of the cathode film was modified to 3.9 g/cc. Further, the lithium-ion secondary battery was manufactures in the same way as in Example 1.

### Example 7

LiCoO₂ having a particle size D50 of 18 μm was used as the lithium cobalt oxide-based active material A, and Li_{1.00}Ni_{0.83}Co_{0.17}O₂ having a particle size D50 of 13 μm was used as the nickel-based active material B, which was pretreated in the same way as in Example 1. The mass ratio B/A of the nickel-based active material B and the lithium cobalt oxide-based active material A was adjusted to 1.67. The compacted density of the cathode film was modified to 3.9 g/cc. Further, the lithium-ion secondary battery was manufactures in the same way as in Example 1.

### Example 8

LiCoO₂ having a particle size D50 of 18 μm was used as the lithium cobalt oxide-based active material A, and Li_{0.81}Ni_{0.83}Co_{0.14}Al_{0.03}O₂ having a particle size D50 of 15 μm was used as the nickel-based active material B, which was pretreated in the same way as in Example 1. The mass ratio B/A of the nickel-based active material B and the lithium cobalt oxide-based active material A was adjusted to 1.67. The compacted density of the cathode film was modified to 3.9 g/cc. Further, the lithium-ion secondary battery was manufactures in the same way as in Example 1.

### Example 9

LiCoO₂ having a particle size D50 of 18 μm was used as the lithium cobalt oxide-based active material A, and Li_{0.99}Ni_{0.75}Co_{0.24}Al_{0.01}O₂ having a particle size D50 of 13 μm was used as the nickel-based active material B, which was pretreated in the same way as in Example 1. The mass ratio B/A of the nickel-based active material B and the lithium cobalt oxide-based active material A was adjusted to 1.67. The compacted density of the cathode film was modified to 3.9 g/cc. Further, the lithium-ion secondary battery was manufactures in the same way as in Example 1.

TABLE 1
the specific capacity achieved by the cathode film prepared
by using different nickel-based active material B and lithium
cobalt oxide-based active material A at a B/A of 1.67

| | | Formula of the nickel-based | 0.2 C specific |
|---|---|---|---|
| | B/A | active material | capacity (mAh/g) |
| Example 2 | 1.67 | Li_{1.02}Ni_{0.78}Co_{0.20}Al_{0.02}O₂ | 166.0 |
| Example 5 | 1.67 | Li_{0.98}Ni_{0.77}Co_{0.20}Al_{0.01}Mn_{0.02}O₂ | 161.9 |
| Example 6 | 1.67 | Li_{1.07}Ni_{0.78}Co_{0.20}O₂ | 171.3 |
| Example 7 | 1.67 | Li_{1.00}Ni_{0.83}Co_{0.17}O₂ | 160.0 |
| Example 8 | 1.67 | Li_{0.81}Ni_{0.83}Co_{0.14}Al_{0.03}O₂ | 165.6 |
| Example 9 | 1.67 | Li_{0.99}Ni_{0.75}Co_{0.24}Al_{0.01}O₂ | 166.3 |

### Example 10

Li_{1.05}Co_{0.99}Mg_{0.001}O₂ having a particle size D50 of 22 μm was used as the lithium cobalt oxide-based active material A, and Li_{1.02}Ni_{0.78}Co_{0.20}Al_{0.02}O₂LiNi_{0.78}CO_{0.19}Al_{0.02}O₂ having a particle size D50 of 12 μm was used as the nickel-based active material B, which was pretreated in the same way as in Example 1. The mass ratio B/A of the nickel-based active material B and the lithium cobalt oxide-based active material A was adjusted to 1.67. The compacted density of the cathode film was modified to 4.0 g/cc. Further, the lithium-ion secondary battery was manufactures in the same way as in Example 1.

### Example 11

Li_{1.15}CoO₂ having a particle size D50 of 17 μm was used as the lithium cobalt oxide-based active material A, and Li_{1.02}Ni_{0.78}Co_{0.20}Al_{0.02}O₂LiNi_{0.78}Co_{0.19}Al_{0.02}O₂ having a particle size D50 of 12 μm was used as the nickel-based active material B, which was pretreated in the same way as in Example 1. The mass ratio B/A of the nickel-based active material B and the lithium cobalt oxide-based active material A was adjusted to 1.67. The compacted density of the cathode film was modified to 4.0 g/cc. Further, the lithium-ion secondary battery was manufactures in the same way as in Example 1.

TABLE 2
the specific capacity of the cathode film prepared by using
different lithium cobalt oxide-based active material A
and nickel-based active material B at a B/A of 1.67

| | | | | Average | |
|---|---|---|---|---|---|
| | | | Com- | Particle | 0.2 C |
| | | Formula of lithium | pacted | size | Specific |
| | | cobalt oxide-based | density | D50 | capacity |
| | B/A | active material A | (g/cc) | (μm) | (mAh/g) |
| Exam- | 1.67 | LiCoO2 | 3.90 | 18.0 | 166.0 |
| ple 2 | | | | | |
| Exam- | 1.67 | Li1.05Co0.99Mg0.01O2 | 4.00 | 21.5 | 164.0 |
| ple 10 | | | | | |
| Exam- | 1.67 | Li1.15CoO2 | 3.90 | 17.4 | 164.6 |
| ple 11 | | | | | |

It can be seen from table 2 that lithium cobalt oxide-based active material A having different D50 has a relatively large effect on the compacted density of the mixed cathode film.

### Example 12

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, the surface of which was surface coating with a layer of ZrO₂ by liquid phase deposition. The mass ratio B/A of the nickel-based active material B and the lithium cobalt oxide-based active material A was adjusted to 1.67. The compacted density of the cathode film was modified to 3.9 g/cc. Further, the lithium-ion secondary battery was manufactures in the same way as in Example 1.

The surface of the active material B was surface coating with ZrO₂ as follows: adding 10 kg Li_{1.02}Ni_{0.78}Co_{0.20}Al_{0.02}O₂ to 20 L aqueous solution containing 1 mol KZrF₆ and 10 mol LiNO₃, adding 0.5 mol/L ammonia water to adjust the pH of the solution to 8, rapid stirring the solution at 60° C. for 15 minutes, centrifuging the solution to separate Li_{1.02}Ni_{0.78}CO_{0.20}Al_{0.02}O₂ sample, drying the sample at 80° C. for 10 hours, and baking the dried sample at 750° C. for 2 hours to provide a final Li_{1.02}Ni_{0.78}Co_{0.20}Al_{0.02}O₂ material with ZrO₂ surface coating thereof.

### Example 13

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, the surface of which was surface coating with a layer of Al₂O₃ by liquid phase deposition. The mass ratio B/A of the nickel-based active material B and the lithium cobalt oxide-based active material A was adjusted to 1.67. The compacted density of the cathode film was modified to 3.9 g/cc. Further, the lithium-ion secondary battery was manufactures in the same way as in Example 1.

The surface of the active material B was surface coating with Al₂O₃ as follows: adding 10 kg Li_{1.02}Ni_{0.78}Co_{0.20}Al_{0.02}O₂ to 20 L aqueous solution containing 1 mol Al(NO₃)₃ and 10 mol LiNO₃, adding 0.5 mol/L ammonia water to adjust the pH of the solution to 8, rapid stirring the solution at 45° C. for 15 minutes, centrifuging the solution to separate Li_{1.02}Ni_{0.78}CO_{0.20}Al_{0.02}O₂ sample, drying the sample at 80° C. for 10 hours, and baking the dried sample at 750° C. for 2 hours to provide a final Li_{1.02}Ni_{0.78}Co_{0.20}Al_{0.02}O₂ material with Al₂O₃ surface coating thereof.

### Example 14

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, the surface of which was surface coating with a layer of ZnO₂ by liquid phase deposition. The mass ratio B/A of the nickel-based active material B and the lithium cobalt oxide-based active material A was adjusted to 1.67. The compacted density of the cathode film was modified to 3.9 g/cc. Further, the lithium-ion secondary battery was manufactures in the same way as in Example 1.

The surface of the active material B was surface coating with ZnO₂ as follows: adding 10 kg Li_{1.02}Ni_{0.78}Co_{0.20}Al_{0.02}O₂ to 20 L aqueous solution containing 0.5 mol ZnF₂ and 10 mol LiNO₃, rapid stirring the solution at 45° C. for 30 minutes, centrifuging the solution to separate Li_{1.02}Ni_{0.78}CO_{0.20}Al_{0.02}O₂ sample, drying the sample at 80° C. for 10 hours, and baking the dried sample at 750° C. for 2 hours to provide a final Li_{1.02}Ni_{0.78}Co_{0.20}Al_{0.02}O₂ material with ZnO₂ surface coating thereof.

### Example 15

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, the surface of which was surface coating with a layer of TiO₂ by liquid phase deposition. The mass ratio B/A of the nickel-based active material B and the lithium cobalt oxide-based active material A was adjusted to 1.67. The compacted density of the cathode film was modified to 3.9 g/cc. Further, the lithium-ion secondary battery was manufactures in the same way as in Example 1.

The surface of the active material B was surface coating with TiO₂ as follows: adding 10 kg Li_{1.02}Ni_{0.78}Co_{0.20}Al_{0.02}O₂ to 20 L ethanol solution containing 0.2 mol Ti(OBu)₄, rapid stirring the solution at 25° C. for 30 minutes, centrifuging the solution to separate Li_{1.02}Ni_{0.78}CO_{0.20}Al_{0.02}O₂ sample, drying the sample under a vacuum of lower than 100 Pa at 80° C. for 10 hours, and baking the dried sample at 750° C. for 2 hours to provide a final Li_{1.02}Ni_{0.78}CO_{0.20}Al_{0.02}O₂ material with TiO₂ surface coating thereof.

TABLE 3
the specific capacity of the cathode film prepared by nickel-
based active material B subjected to different surface coating
treatment and lithium cobalt oxide-based active material A and
at a B/A of 1.67 and the thickness swelling rate of 4.2 V complete
battery prepared using the cathode film and subjected to high-
temperature storage at 85° C. for 4 hours.

| | | Surface coating | 0.2 C | 85 deg. C./4 h |
|---|---|---|---|---|
| | | layer of the | specific | thickness |
| | | nickel-based | capacity | swelling |
| | B/A | active material B | (mAh/g) | rate |
| Example 12 | 1.67 | ZrO₂ | 164 | 26.5% |
| Example 13 | 1.67 | Al₂O₃ | 163 | 9.7% |
| Example 14 | 1.67 | ZnO₂ | 163 | 15.4% |
| Example 15 | 1.67 | TiO₂ | 162 | 18.6 |
| Comparative | 1.67 | Untreated (non- | 166 | 32.8% |
| example 5 | | surface coating) | | |

It can be seen from table 3 that the battery comprising the nickel-based active material B subjected to surface coating treatment has a significantly reduced thickness swelling rate after being stored at a high temperature of 85° C. for 4 hours.

### Comparative Example 1

LiCoO₂ having a particle size D50 of 18 μm was used as the lithium cobalt oxide-based active material, and the compacted density of the cathode film was adjusted to 4.1 g/cc. Further, the lithium-ion secondary battery was manufactures in the same way as in Example 1.

### Comparative Example 2

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, the surface of which was pretreated in the same way as in Example 1. The mass ratio B/A of the nickel-based active material B and the lithium cobalt oxide-based active material A was adjusted to 0.5. The compacted density of the cathode film was modified to 4.0 g/cc. Further, the lithium-ion secondary battery was manufactures in the same way as in Example 1.

TABLE 4
the compacted density of the cathode films having
different mixing ratio a specific capacity achieved
in the lithium-ion secondary battery

| | | Compacted density | 0.2 C specific |
|---|---|---|---|
| | B/A | (g/cc) | capacity (mAh/g) |
| Comparative example 1 | 0 | 4.10 | 140 |
| Comparative example 2 | 0.5 | 4.00 | 153 |
| example 1 | 0.82 | 4.00 | 158 |
| example 2 | 1.67 | 3.90 | 166 |
| example 3 | 3 | 3.80 | 170 |
| example 4 | 9 | 3.75 | 172 |

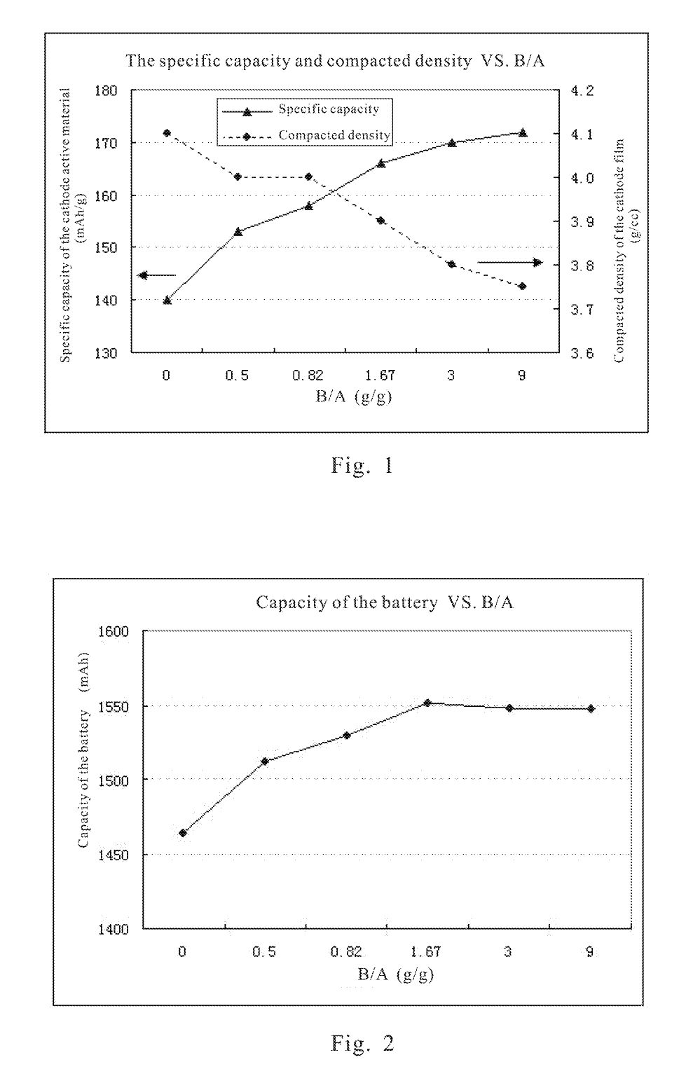

It can be seen from FIG. 1 and table 4 that, as the mass ratio B/A of the nickel-based active material B and lithium cobalt oxide-based active material A increases, the specific capacity of the cathode active material gradually increases, even if the compacted density of the cathode film gradually decreases.

TABLE 5
the average specific capacity, average discharge voltage, average
energy density and thickness swelling rate after high-temperature
storage at 85° C. for 4 hours of the lithium-ion secondary battery
prepared by using cathode films with different mixing ratio.

| | | Discharge | Average | | Energy | 85 deg. C./4 h |
|---|---|---|---|---|---|---|
| | | capacity | discharge | battery size | density | thickness |
| | B/A | (mAh) | voltage (V) | (mm*mm*mm) | (Wh/L) | swelling rate |
| Comparative | 0 | 1464 | 3.78 | 4.16*33.58*80.8 | 490 | 0.5% |
| example 1 | | | | | | |
| Comparative | 0.5 | 1512 | 3.74 | 4.16*33.58*80.8 | 501 | 3.0% |
| example 2 | | | | | | |
| Example 1 | 0.82 | 1530 | 3.72 | 4.16*33.58*80.8 | 504 | 3.8% |
| Example 2 | 1.67 | 1551 | 3.70 | 4.16*33.58*80.8 | 508 | 5.5% |
| Example 3 | 3 | 1548 | 3.69 | 4.16*33.58*80.8 | 506 | 6.3% |
| Example 4 | 9 | 1548 | 3.66 | 4.16*33.58*80.8 | 502 | 13.0% |

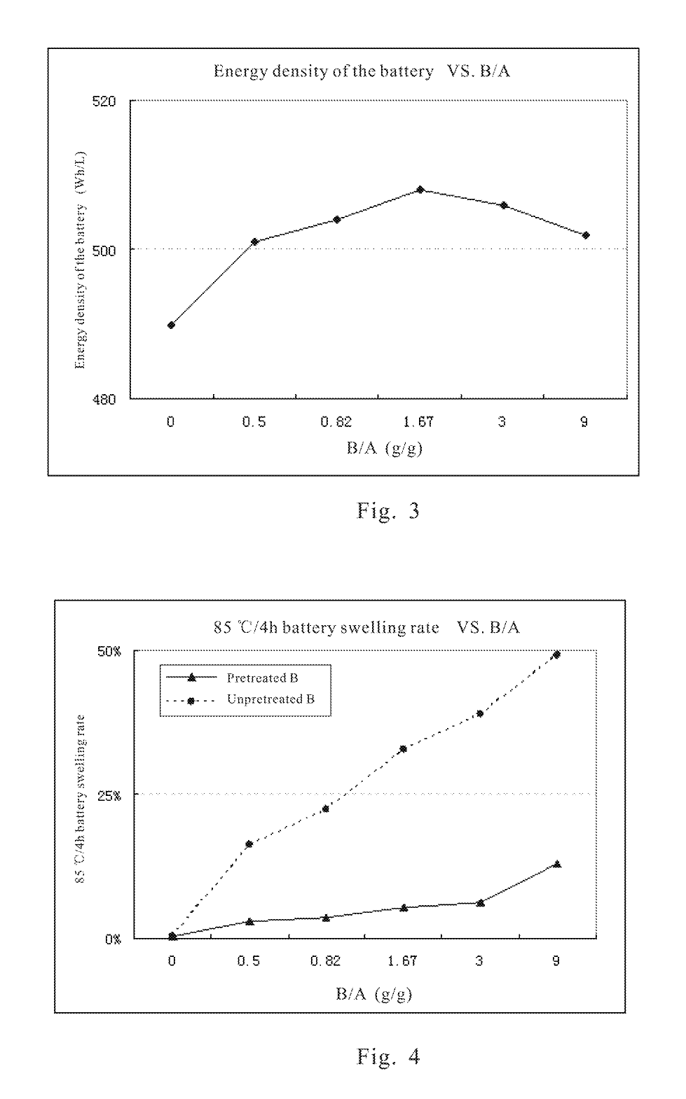

In the table 5, the listed capacity is the discharge capacity achieved at 0.2 C discharge rate at 30° C., and the listed average discharge voltage is the ratio of the discharge energy to the discharge capacity during discharge at 0.2 C at 30° C. The listed 85 deg.C/4 h thickness swelling rate is the thickness swelling rage of the batteries which was first fully charged to 4.2V and then subjected to high-temperature storage at 85° C. for 4 hours. It can be seen from FIGS. 2-3 and table 5 that, as the B/A increases, the capacity and volumetric energy density finally achieved by cathode active materials having different B/A ratio in lithium-ion secondary batteries exhibited a tendency of initial increase and subsequent decrease. In combination with FIG. 4, the thickness swelling rate after high-temperature storage increased by a rate below 13% as B/A increased, complying with the safety requirements for batteries.

### Comparative Example 3

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, the surface of which was not pretreated. The mass ratio B/A of the nickel-based active material B and the lithium cobalt oxide-based active material A was adjusted to 0.5. The compacted density of the cathode film was modified to 4.00 g/cc. Further, the lithium-ion secondary battery was manufactures in the same way as in Example 1.

### Comparative Example 4

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, the surface of which was not pretreated. The mass ratio B/A of the nickel-based active material B and the lithium cobalt oxide-based active material A was adjusted to 0.82. The compacted density of the cathode film was modified to 4.00 g/cc. Further, the lithium-ion secondary battery was manufactures in the same way as in Example 1.

### Comparative Example 5

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, the surface of which was not pretreated. The mass ratio B/A of the nickel-based active material B and the lithium cobalt oxide-based active material A was adjusted to 1.67. The compacted density of the cathode film was modified to 3.9 g/cc. Further, the lithium-ion secondary battery was manufactures in the same way as in Example 1.

### Comparative Example 6

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 12 μm was used as the nickel-based active material B, the surface of which was not pretreated. The mass ratio B/A of the nickel-based active material B and the lithium cobalt oxide-based active material A was adjusted to 3. The compacted density of the cathode film was modified to 3.8 g/cc. Further, the lithium-ion secondary battery was manufactures in the same way as in Example 1.

### Comparative Example 7

LiCoO₂ having a particle size D50 of 18 μm was used as the lithium cobalt oxide-based active material A, and Li_{1.02}Ni_{0.78}Co_{0.20}Al_{0.02}O₂ having a particle size D50 of 121m was used as the nickel-based active material B, the surface of which was not pretreated. The mass ratio B/A of the nickel-based active material B and the lithium cobalt oxide-based active material A was adjusted to 9. The compacted density of the cathode film was modified to 3.75 g/cc. Further, the lithium-ion secondary battery was manufactures in the same way as in Example 1.

TABLE 6
the average capacity, average discharge voltage, average battery energy density and thickness
swelling rage after high-temperature storage at 85° C. for 4 hours of the lithium-
ion secondary battery prepared by cathode films having different mixing ratio.

| | | Discharge | Average | | Energy | 85 deg. C./4 h |
|---|---|---|---|---|---|---|
| | | capacity | discharge | Batter size | density | thickness |
| | B/A | (mAh) | voltage (V) | (mm*mm*mm) | (Wh/L) | swelling rate |
| Comparative | 0 | 1464 | 3.78 | 4.16*33.58*80.8 | 490 | 0.5% |
| example 1 | | | | | | |
| Comparative | 0.5 | 1514 | 3.74 | 4.16*33.58*80.8 | 502 | 16.2% |
| example 3 | | | | | | |
| Comparative | 0.82 | 1533 | 3.72 | 4.16*33.58*80.8 | 505 | 22.5% |
| example 4 | | | | | | |
| Comparative | 1.67 | 1552 | 3.70 | 4.16*33.58*80.8 | 509 | 32.8% |
| example 5 | | | | | | |
| Comparative | 3 | 1549 | 3.69 | 4.16*33.58*80.8 | 506 | 39.0% |
| example 6 | | | | | | |
| Comparative | 9 | 1549 | 3.66 | 4.16*33.58*80.8 | 502 | 49.2% |
| example 7 | | | | | | |

It can be seen from FIG. 4 and table 6 that the batteries comprising nickel-based active material B which was not pretreated had a significant increase in thickness swelling rate after high-temperature storage at 85° C. for 4 hours, and thus failed to meet the safety requirements for batteries.

The capacity of the batteries prepared by using the cathode active materials according the present invention in the above examples is greatly improved (all by 4.5% or higher) compared to the batteries in prior art. Also, the energy density is greatly improved (all by 2.9% or higher) compared to the batteries in prior art.

Changes and modifications to the above embodiments can be made by those skilled in the art according to the disclosure and teachings of the above description. Therefore, the present invention is not limited to the above specific embodiments disclosed and described, and on the contrary, some of the modifications and alterations to the present invention should also fall within the scope defined by the claims as attached. In addition, some of the terms used in the description are used for the purpose of easy understanding, rather than making any limitation to the present invention.

What is claimed is:

1. A cathode material for lithium-ion secondary battery, comprising cathode active material, a binder, and a conductive agent, wherein the cathode active material is a compound material of
lithium cobalt oxide-based active material A, having a formula of LiₓCo_{y}Ma_{(1-y)}O₂, where 0.45≦x≦1.2, 0.8≦y≦1, Ma is one or more of Al, Mn, Fe, Mg, Si, Ti, Zn, Mo, V, Sr, Sn, Sb, W, Ta, Nb, Ge and Ba; and
nickel-based active material B, having a formula of Liₓ₁NiₐCo_{b}Mb_{(1-a-b)}O₂, wherein 0.45≦x1≦1.2, 0.7≦a≦0.9, 0.08≦b≦0.3, 0.78≦a+b≦1, Mb is one ore more of Al, Mn, Mg, Fe, Ti, Zn, Mo, V, Sr, Sn, Sb, W, Ta, Nb, Ge and Ba,
characterized in that the nickel-based active material B is pretreated before being mixed with the lithium cobalt oxide-based active material A, and the mass ratio B/A of the lithium cobalt oxide-based active material A and the nickel-based active material B is between 0.82 and 9.

2. The cathode material for lithium-ion secondary battery according to claim 1, wherein the nickel-based active material B is pretreated by being surface coating with an oxide layer of M on its surface, M being any of Mg, Al, Zr, Zn, Ti, Cu, and B.

3. The cathode material for lithium-ion secondary battery according to claim 1, wherein the nickel-based active material B is pretreated by being washed in de-ionized water, being separated from water, and vacuum dried to remove water.

4. The cathode material for lithium-ion secondary battery according to claim 3, wherein the pH value of the de-ionized water is between 5.5 and 7, the weight ratio of the nickel-based active material B and the de-ionized water is between 1:2 and 1:10, the washing is performed for between 1 and 20 minutes, and the vacuum drying is performed under a vacuum of lower than 100 Pa at 80-150° C. for 10-20 hours.

5. The cathode material for lithium-ion secondary battery according to claim 1, wherein the lithium cobalt oxide-based active material A has an average particle size D50 of between 15 and 22 μm, the nickel-based active material B has an average particle size D50 of between 8 and 14 μm, and the ratio of the D50 of the lithium cobalt oxide-based active material A to that of the nickel-based active material B is between 1.07 and 2.75.

6. The cathode material for lithium-ion secondary battery according to claim 1, wherein the cathode material has a compacted density larger than or equal to 3.7 g/cc.

7. The cathode material for lithium-ion secondary battery according to claim 1, wherein the mass ratio B/A of the lithium cobalt oxide-based active material A and the nickel-based active material B is between 1.5 and 9.

8. The cathode material for lithium-ion secondary battery according to claim 7, wherein the mass ratio B/A of the lithium cobalt oxide-based active material A and the nickel-based active material B is 1.67.

9. The cathode material for lithium-ion secondary battery according to claim 1, wherein the lithium cobalt oxide-based active material A is LiCoO₂ having a particle size D50 of 18 μm, and the nickel-based active material B is Li_{1.02}Ni_{0.78}Co_{0.20}Al_{0.02}O₂ having a particle size D50 of 12 μm.

10. A lithium-ion secondary battery, comprising a cathode, an anode, electrolyte, and a separator membrane, wherein the cathode is the cathode material of any one of claim 1 to claim 9.
